(19) United States
(12) Patent Application Publication
(10) Pub. No.: US 2013/0103724 A1
(43) Pub. Date: Apr. 25, 2013

(54) NETWORK AND METHOD FOR MANAGING MODELS

(71) Applicants: Hongxiang Qiu, Shanghai (CN); Qiying Gong, Shanghai (CN); Bo Su, Shanghai (CN)

(72) Inventors: Hongxiang Qiu, Shanghai (CN); Qiying Gong, Shanghai (CN); Bo Su, Shanghai (CN)

(73) Assignee: GENERAL ELECTRIC COMPANY, Schenectady, NY (US)

(21) Appl. No.: 13/401,944

(22) Filed: Feb. 22, 2012

(30) Foreign Application Priority Data
Oct. 25, 2011 (CN) 201120510470.4

(51) Int. Cl. G06F 17/30

(52) U.S. Cl. 707/809; 707/E17.045

(57) ABSTRACT

A method of managing models in a network includes receiving at a model manager a model of a controlled system in a first format from a first system and storing the model in a second format in the model manager. Storing includes several steps that allow for the transformation of the model into a different, version-free format so that the network can adapt to changes in the first format.

### CROSS-REFERENCE TO RELATED APPLICATIONS AND PRIORITY CLAIM

This application claims the benefit of Chinese Patent Application for Utility Model No. 201120510470.4, entitled “NETWORK AND METHOD FOR MANAGING MODELS”, filed Oct. 25, 2011, which is incorporated herein by reference in its entirety.

### BACKGROUND OF THE INVENTION

The subject matter disclosed herein relates to models and, in particular, to managing models among different systems that control a distribution network.

Energy providers can be responsible for vast energy production and distribution networks. These networks can include several different systems that need to communicate in order to function effectively. One problem that exists, however, is that each of these systems can represent the same information in different manners. For example, a utility provider may have one system that records and stores geographic information about its distribution system and is generally referred to as a geographic information system (GIS). The provider may have another system referred to as a distribution management system (DMS) that controls operation of the distribution system.

A smart grid is a type of distribution network that attempts to predict and intelligently respond to the behavior and actions of all electric power consumers. Such systems typically require both a GIS and a DMS and communication between them. In more detail, in order for the DMS to effectively manage the distribution system, it needs to have information that describes the location and/or type of components of the distribution network. In many cases, the GIS and DMS may natively characterize components in a different manner. To alleviate such differences, a common information model (CIM) has been developed to describe elements of a distribution system. However, the CIM is ever evolving and the GIS and DMS may operate, for example, on different versions of the particular CIM. The term “model management” is used herein to refer to the process(es) associated with maintaining consistency of models between the various systems of a distribution system (e.g., between the GIS and DMS). In the absence of model management, various systems cannot effectively communicate. Indeed, if the CIM standard changes, one or more of the systems will have to be updated with the new standards and the models it creates recreated. The recreated models can then be transferred to a requesting system. However, such operation can require frequent updates and, in some cases, require restarts of systems.

### BRIEF DESCRIPTION OF THE INVENTION

According to one aspect of the invention, a network for managing models includes a first system that provides a model of a controlled system in a first format where the model includes a plurality of instances each being of a particular class type. In this aspect, the network also includes a model manager that receives the model and stores it in a second format and a second system that requests some or all of the model from the model manager in a third format. In this aspect, the model manager stores the model in the second format by: forming an instance table that includes an entry for each instance in the model that includes a class of the instance and a name of the instance; forming an attribute table that includes an entry for each instance in the model and a value of at least one attribute of the instances; forming a relation table that includes an entry of each of the instances, each entry in the relation table including a pointer to at least one other instance; and storing the instance table, the attribute table and the relation table.

According to another aspect of the invention, a method of managing models in a network includes receiving at a model manager a model of a controlled system in a first format from a first system and storing the model in a second format in the model manager. In this aspect, storing includes forming an instance table that includes an entry for each instance in the model that includes a class of the instance and a name of the instance; forming an attribute table that includes an entry for each instance in the model and a value of at least one attribute of the instances; forming a relation table that includes an entry of each of the instances, each entry in the relation table including a pointer to at least one other instance; and storing the instance table, the attribute table and the relation table. The method of this aspect also includes receiving a request for some or all of the model from the model manager in a third format from a second system and providing the model to the second system in the third format.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating a system in which embodiments of the present invention may be deployed;

FIG. 2 illustrates three tables utilized according to one embodiment;

FIG. 3 illustrates three additional tables that may be utilized in combination with the tables shown in FIG. 2; and

FIG. 4 is a block diagram of a computing system on which embodiments of the present invention can be implemented.

The detailed description explains embodiments of the invention, together with advantages and features, by way of example with reference to the drawings.

### DETAILED DESCRIPTION OF THE INVENTION

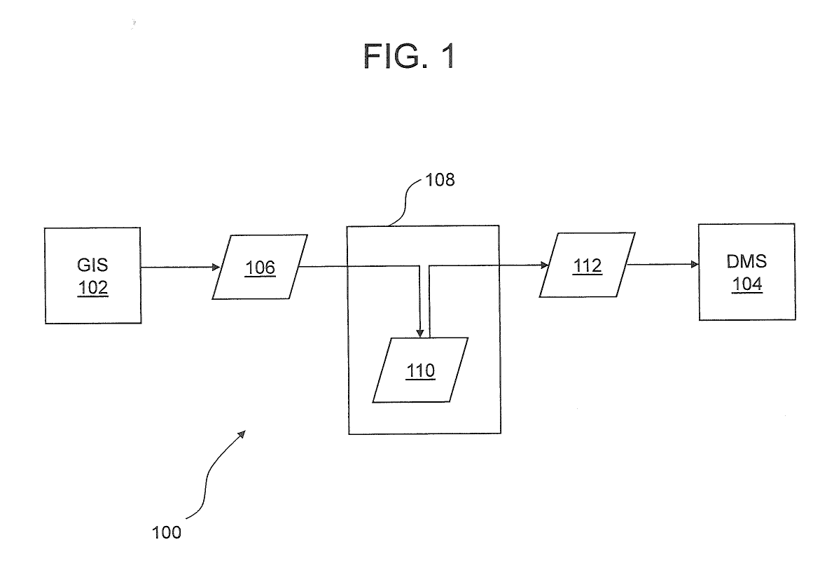

FIG. 1 illustrates a network 100 that includes a plurality of systems 102, 104. In one embodiment, the system 102 in a GIS and the system 104 is a DMS system. Systems 102 and 104 shall be referred to herein as GIS 102 and DMS 104, respectively. It shall be understood that the teachings herein could be applied to any systems in a smart grid system or even to any systems in any type of network.

According to one embodiment, the GIS 102 produces a network model 106 that is provided in the format of the particular CIM version that it supports. The network model 106 can include, for example, a model of connections between elements (connectivity model) and graphical representations of that model (e.g., geospatial or orthographic representations).

The GIS 102 provides the network model 106 to a model manager 108. In general and as described in more detail below, the model manager 108 converts the network model 106 into one or more tables 110. These tables are not constrained by any schema from the CIM version. From these tables, a network model 112 can be formed in the CIM version supported by the DMS 104. In this manner, regardless of whether the GIS 102 and the DMS 104 include the same version, the two can communicate models between themselves via the model manager 108. One or both of the network models 106, 112 can be resource description framework (RDF) files in one embodiment.

CIM includes many different classes, each class representing a particular type of real world objects or data. Each class includes multiple properties. Each real word object is formed as an instance and can include the property information. For example, a particular instance can include attributes and relations. The attributes can include, for example, operating characteristics/constraints of a particular transformer and the relations can include an indication of one or more other components (instances) to which the particular transformer is connected.

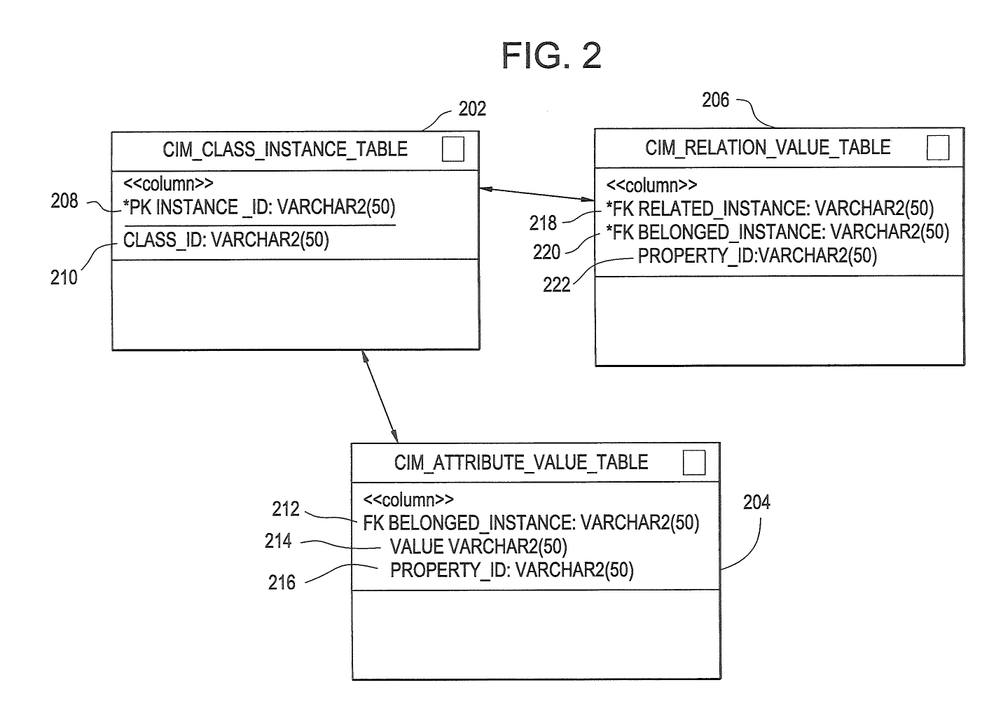

FIG. 2 illustrates three tables that can form, for example, part of table 110 of FIG. 1. The illustrated tables include a CIM_CLASS_INSTANCE_TABLE (instance table) 202, a CIM_ATTRIBUTE_VALUE_TABLE (attribute table) 204, and a CIM_RELATION_VALUE_TABLE (relation table) 204. These three tables are used to store the instance data contained in a complete RDF file or messages that form part of an RDF file. For example, the tables 202, 204, 206 can include instance data contained in the network model 106.

In more detail, the instance table 202 is used to store a listing of all the instances of a particular class. As such, the instance table 202 includes a first column 208 that includes the unique ID (INSTANCE_ID) for the object. The instance table 202 also includes a second column 210 (CLASS_ID), which points to detailed class information for the class of which the object is a member and that is contained in a class table as described below. The attribute table 204 is used to store the attributes of the particular instance and includes a first column 212 (BELONGED_{—} INSTANCE) that stores the object ID, which points to the INSTANCE_ID 208 in table 202. The instance table 202 also includes a second column 214 (VALUE) that is used to store the attribute value for the specified attribute name in the third column 216 (PROPERTY_ID). The third row 216 points to detailed property information in a property table described below.

Relation table 206 is used to store the relations (associations) for the objects in table 202. Relation table 206 includes a first column 218 (RELATED_INSTANCE) that identifies other objects to which a particular object (second column 220 (BELONGED_INSTANCE) is related. Relation table 206 also includes a third column 222 (PROPERTY_ID) that points to the detailed relation information (e.g., the property that the relation defines) in a property table as described below. As can be seen in FIG. 2, each object gets a separate entry in two or more of the tables 202, 204, 206 that identify the object (instance table 202), the objects attributes (attribute table 204) and the other objects to which it is related (relation table 206). Further, such a representation is independent of a particular CIM standard/schema is, as such, generic. Thus, even if a new class or property is introduced, tables having the same format as shown in FIG. 2 can still be used.

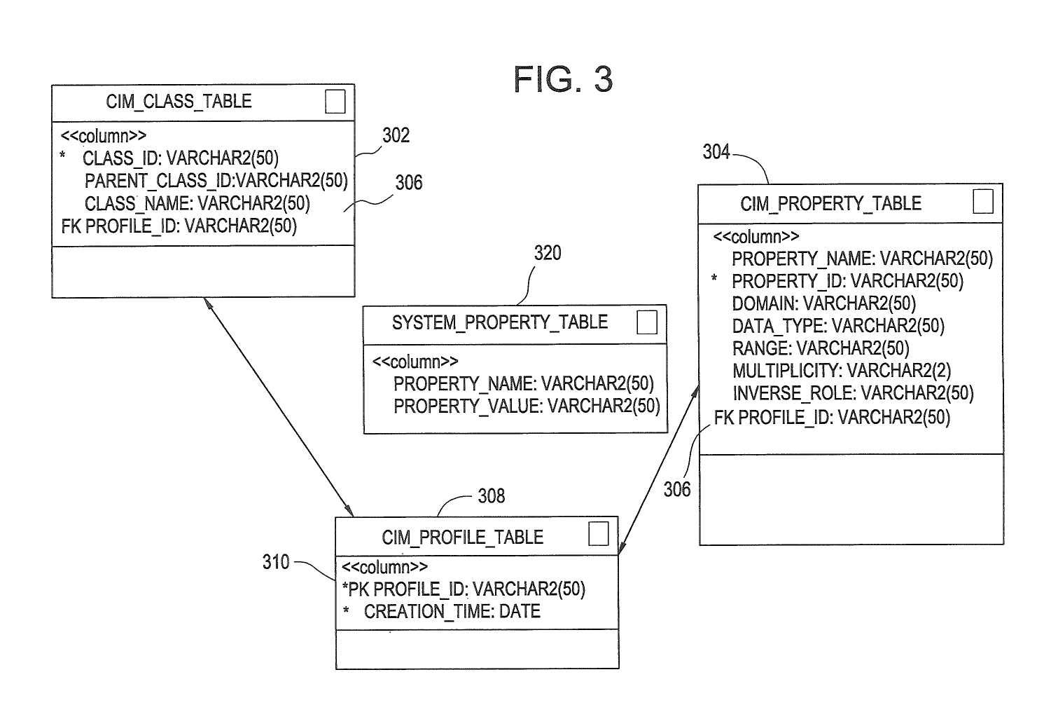

As described generally above, three other tables can be provided to complete the storage of a particular RDF file. These tables are illustrated in FIG. 3 and include a CIM_CLASS_TABLE (class table) 302, a CIM_PROPERTY TABLE (property table) 304 and CIM_PROFILE_(profile table) 308. Class table 302 is used to store the classes that form the CIM RDF schema that applies to the model. Property table 304 is used to store information for properties from the CIM RDF schema. In one embodiment, both of them have a same column PROFILE_ID 306, which points to profile table 308 that identifies the particular version of the CIM profile being utilized. Finally, the tables can also include a SYSTEM_PROPERTY_TABLE (system property table) 320, which is used to set the current supported model for the system 100 (FIG. 1).

Referring now to both FIGS. 1 and 2, according to one embodiment, the second column 210 of table 202 points to a particular entry in class table 302 and the third column 222 points to a particular entry in the property table 304. In this manner, detailed class information about the particular instances as well as detailed property information about relations between instances can be maintained in a manner that is independent of the particular CIM RDF schema in which the network model was created.

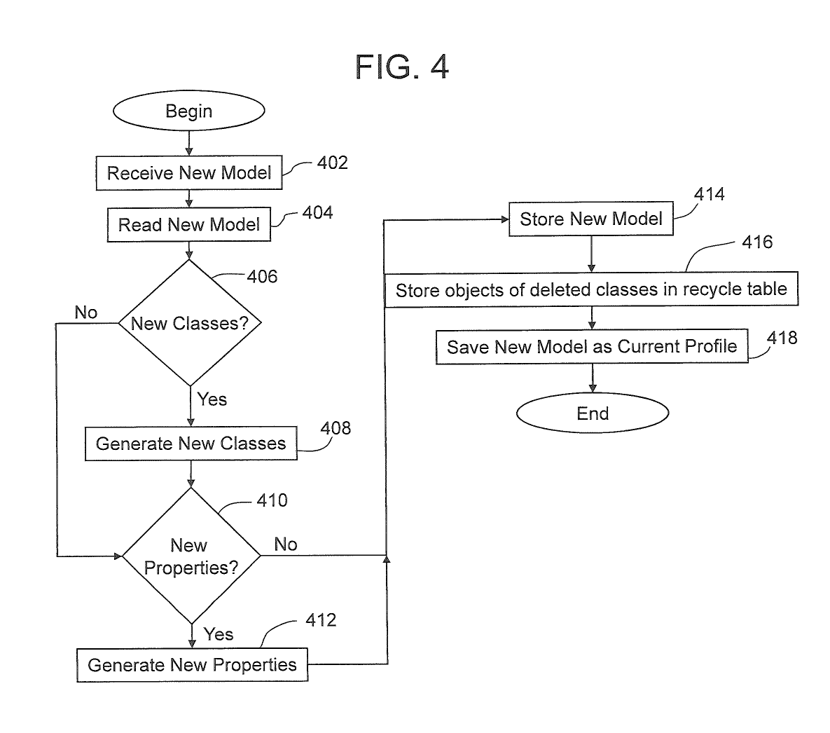

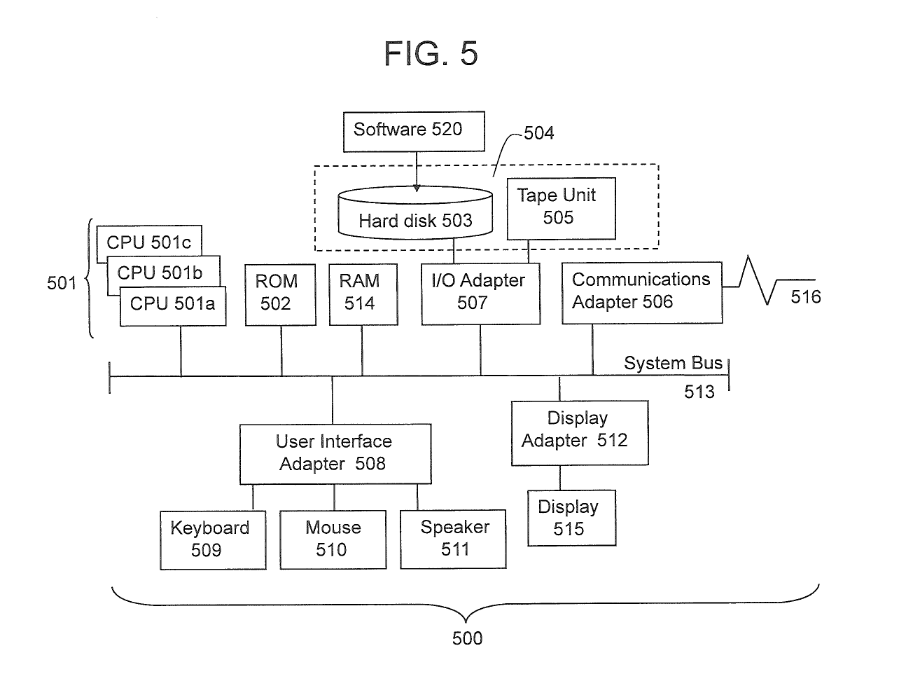

A better understanding of embodiments of the present invention may be had by explaining how a new network model (or message with a part of a model) can be added to the MEP 108 of FIG. 1. It is assumed that the new network model is in a different CIM version than the old one. Reference is now made to FIGS. 1 to 4 where FIG. 4 shows a block diagram of a method according to one embodiment. First, the new model is received at block 402 and then read at block 404. If any new classes exist in the new model that were not in the old model as determined at block 406, new CLASS_IDs are generated for the new classes at block 408. Similarly, if new properties exist as determined at block 410, new PROPERTY_IDs are generated for them at block 412. At block 414, the new model is then stored in the manner described above with respect to FIG. 2-3 for each instance. To the extent that any classes are deleted, the objects from the class table 202, the attribute table 204, and the relation table 204 that are of those classes are stored in recycle tables at block 416. Such recycle tables can be used to revert back to a last save model if needed. Then, at block 418 the new imported model is saved as the current profile in the system property 320.

In prior applications, if the CIM standard had changed, that new standard would have to have been added to the model manager 108. In some instances, the model manager 108 would have to have been restarted. According to the above description, it is clear that the introduction of a new standard only requires creation or deletion of classes and variation of properties in the tables 110.

It shall be understood that in some instances the DMS 104 may request some or all of the network model 106. The DMS 104 may specify, for example, that it wants the model for a particular branch of a distribution network. When such a request is received, the model manager 108 consults the tables 110 formed as described above and, starting with the first instance in the branch (e.g., the root) can create all connections based on following the relations in table 204. Of course, for each instance, values can be attached per table 206 for the properties in the property table 304. In this manner, the model manager 108 can create the requested model 112 for the DMS 104. In view of the above, a technical effect of embodiments of the present invention allows for the transfer of a model between disparate systems without having to update a model manager each time a new CIM version changes.

FIG. 5 shows an example of a computing system 500 on which embodiments of the present invention may be implemented. For example, the computing system 500 could be included as part of the model manager 108 of FIG. 1. In this embodiment, the system 500 has one or more central processing units (processors) 501a, 501b, 501c, etc. (collectively or generically referred to as processor(s) 501). In one embodiment, each processor 501 may include a reduced instruction set computer (RISC) microprocessor. Processors 501 are coupled to system memory 514 and various other components via a system bus 513. Read only memory (ROM) 502 is coupled to the system bus 513 and may include a basic input/output system (BIOS), which controls certain basic functions of the system 500.

FIG. 5 further depicts an input/output (I/O) adapter 507 and a network adapter 506 coupled to the system bus 513. The I/O adapter 507 may be a small computer system interface (SCSI) adapter that communicates with a hard disk 503 and/or tape storage drive 505 or any other similar component. The I/O adapter 507, hard disk 503, and tape storage device 505 are collectively referred to herein as mass storage 504. A network adapter 506 interconnects bus 513 with an outside network 516 enabling the computing system 500 to communicate with other such systems. A screen (e.g., a display monitor) 515 is connected to system bus 513 by a display adaptor 512, which may include a graphics adapter to improve the performance of graphics intensive applications and a video controller. In one embodiment, adapters 507, 506, and 512 may be connected to one or more I/O busses that are connected to system bus 513 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 513 via user interface adapter 508 and display adapter 512. A keyboard 509, mouse 510, and speaker 511 are all interconnected to bus 513 via user interface adapter 508, which may include, for example, a Super I/O chip integrating multiple device adapters into a single integrated circuit.

Thus, as configured in FIG. 5, the system 500 includes processing means in the form of processors 501, storage means including system memory 514 and mass storage 504, input means such as keyboard 509 and mouse 510, and output means including speaker 511 and display 515.

It will be appreciated that the system 500 can be any suitable computer or computing platform, and may include a terminal, wireless device, information appliance, device, workstation, mini-computer, mainframe computer, personal digital assistant (PDA) or other computing device. It shall be understood that the system 500 may include multiple computing devices linked together by a communication network. For example, there may exist a client-server relationship between two systems and processing may be split between the two.

The system 500 also includes a network interface506 for communicating over a network 516. The network 516 can be a local-area network (LAN), a metro-area network (MAN), or wide-area network (WAN), such as the Internet or World Wide Web. Users of the system 500 can connect to the network through any suitable network interface506 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 500 includes machine-readable instructions stored on a tangible machine readable media (for example, the hard disk 503) for capture and interactive display of information shown on the display 515 of a user. As discussed herein, the instructions are referred to as “software” 520. The software 520 may be produced using software development tools as are known in the art. The software 520 may include various tools and features for providing user interaction capabilities as are known in the art.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for managing models comprising:
a first system that provides a model of a controlled system in a first format, the model including a plurality of instances, each instance being of a particular class type;
a model manager that receives the model and stores it in a second format; and
a second system that requests some or all of the model from the model manager in a third format;
wherein the model manager stores the model in the second format by: forming an instance table that includes an entry for each instance in the model that includes a class of the instance and a name of the instance; forming an attribute table that includes an entry for each instance in the model and a value of at least one attribute of the instances; forming a relation table that includes an entry of each of the instances, each entry in the relation table including a pointer to at least one other instance; and storing the instance table, the attribute table and the relation table.

2. The system of claim 1, wherein the model manager forms: a class table that stores a schema of the first format; a property table that stores information for properties of the schema of the first format; and a profile table that identifies the first format.

3. The system of claim 2, wherein the model manager stores the class table, the property table and the profile table as part of storing the model in the second format.

4. The system of claim 2, wherein entries in the instance table include a pointer to an entry related to a particular class in the class table.

5. The system of claim 2, wherein entries in the attribute table include a pointer to an entry related to a particular property in the property table.

6. The system of claim 2, wherein entries in the relation table include a pointer to an entry related to a particular property in the property table.

7. The system of claim 1, wherein the model manager produces the model in the third format from the model in the second format.

8. The system of claim 7, wherein the first format and the second format are the same.

9. The system of claim 1, wherein the first system is a geographic information system and the second system is a distribution management system.

10. The system of claim 1, wherein the controlled system is an electrical distribution network.

11. A method of managing models in a network, the method comprising:
receiving at a model manager a model of a controlled system in a first format from a first system, the model including a plurality of instances, each instance being of a particular class type;
storing the model in a second format in the model manager, storing including:
forming an instance table that includes an entry for each instance in the model that includes a class of the instance and a name of the instance;
forming an attribute table that includes an entry for each instance in the model and a value of at least one attribute of the instances;
forming a relation table that includes an entry of each of the instances, each entry in the relation table including a pointer to at least one other instance; and
storing the instance table, the attribute table and the relation table; and
receiving a request for some or all of the model from the model manager in a third format from a second system; and
providing the model to the second system in the third format.

12. The method of claim 11, wherein storing further comprises:
forming a class table that stores a schema of the first format;
forming a property table that stores information for properties of the schema of the first format; and
forming a profile table that identifies the first format.

13. The method of claim 12, wherein storing further comprises:
storing the class table, the property table and the profile table.

14. The method of claim 12, wherein entries in the instance table include a pointer to an entry related a particular class in the class table.

15. The method of claim 12, wherein entries in the attribute table include a pointer to an entry related a particular property in the property table.

16. The network of claim 12, wherein entries in the relation table include a pointer to an entry related to a particular property in the property table.

17. The method of claim 11, further comprising:
forming in the model manager the model in the third format from the model in the second format.

18. The method of claim 17, wherein the first format and the second format are the same.

19. The method of claim 11, wherein the first system is a geographic information system and the second system is a distribution management system.

20. The method of claim 11, wherein the controlled system is an electrical distribution network.
